(19) United States
(12) Patent Application Publication
(10) Pub. No.: US 2025/0122346 A1
(43) Pub. Date: Apr. 17, 2025

(54) AROMATIC POLYIMIDE SUBSTRATE FOR OPTICAL DISPLAYS AND METHOD OF MANUFACTURE

(71) Applicant: Akron Polymer Systems, Inc., Akron, OH (US)

(72) Inventors: Zhen Li, Hudson, OH (US); Lang Hu, Tallmadge, OH (US); Limin Sun, Copley, OH (US); Frank W. Harris, Boca Raton, FL (US); Dong Zhang, Hudson, OH (US)

(73) Assignee: Akron Polymer Systems, Inc., Akron, OH (US)

(21) Appl. No.: 18/609,254

(22) Filed: Mar. 19, 2024

Related U.S. Application Data
(60) Provisional application No. 63/590,965, filed on Oct. 17, 2023.

(51) Int. Cl. C08J 5/18; C08G 73/10; G02B 1/04

(52) U.S. Cl. CPC C08J 5/18; C08G 73/10; G02B 1/04; C08J 2379/08

(57) ABSTRACT

Disclosed herein is a method for the preparation of an aromatic polyimide substrate for optical displays that can be carried out during the manufacture of the display, The process includes the steps of applying a solution of an aromatic tetracarboxylic acid or an aromatic tetracarboxylic acid derivative and a low molecular weight polyamic acid on a solid support and heating to 425° C. to 450° C. The polyamic acid is prepared from non-stoichiometric amounts of BPDA and PDA. The tetracarboxylic acid is BPTA or PMA. The solution has a solids content of 15 to 25 wt % and an apparent viscosity of 2,000 to 10,000 cPs. The substrate has an elongation to break of greater than 30%, a modulus greater than 8 GPa, a maximum stress to break greater than 400 MPa, and a yellowness factor b*<25. For display manufacturing, the substrate has a softening temperature above 450° C.

### CROSS-REFERENCE TO RELATED APPLICATIONS

The present application claims priority to U.S. provisional application Ser. No. 63/590,965, titled “Aromatic Polyimide Substrate for Optical Displays and Method of Manufacture,” filed Oct. 17, 2023, which is fully hereby incorporated by reference herein.

### FIELD OF THE INVENTION

This disclosure generally relates to a method for preparing a flexible polyimide film substrate for optical displays. More specifically, this disclosure relates to flexible substrates prepared by heating to high temperatures a solution of a tetracarboxylic acid or a tetracarboxylic acid derivative and a polyamic acid that has been cast on a solid substrate. The solution has a low viscosity and high solids content. The method, which can be carried out during the manufacture of the displays, results in a film substrate with excellent mechanical, optical, and thermal properties.

### BACKGROUND OF THE INVENTION

Flexible displays are under development that are light, thin, and non-fragile so there are unlimited product design possibilities. Compared with liquid crystal displays (hereinafter, may be abbreviated as LCDs), organic light-emitting diode (hereinafter, may be abbreviated as OLED) displays have a simpler structure and are more suitable for making flexible displays. The market size of OLED displays has been increasing rapidly in the past several years. OLED displays have high luminous efficiency and high contrast, and can be widely used in mobile phones, digital cameras, navigators, commercial signs, etc. A major factor in their increased use in these areas has been the development of active-matrix OLEDs (hereinafter, may be abbreviated as AMOLED) which provide low energy consumption, fast response times, and high resolution. These highly desirable properties depend largely on the processing temperature of the AMOLED electronic components. In their manufacture the thin film transistor (hereinafter, may be abbreviated as TFT) array of the AMOLED is deposited on a hard substrate at high temperatures. The deposition temperature has a great influence on the electronic characteristics of the TFT. Glass is a normal hard substrate material because it can withstand extremely high deposition temperatures (greater than 500° C.), resulting in TFTs with excellent characteristics. But the glass itself is thick, heavy, and fragile, which limits the design and diversity of display products. This had led to mobile phone makers searching for lightweight, thin, and unbreakable displays. This in turn has led to the search for polymer-based substrate materials, which could enable such flexible displays. Due to their low specific gravity, good flexibility, non-fragility, and ability to be made into thin films, polymer materials are ideal candidates for substrate materials in flexible electronic devices. Thus, there has been considerable effort to develop manufacturing processes for such devices. WO2005/050754 discloses a process whereby a parylene film is deposited on a rigid substrate followed by the construction of an electronic device on the film surface. The finished device is released from the rigid substrate so that the parylene film functions as the device substrate. However, parylene is not thermally stable enough to withstand the processing temperatures of most displays.

Aromatic polyimides are known for their excellent thermal and mechanical properties and are the best candidates for substrate materials for flexible displays such as OLEDs. In the classic preparation process, an aromatic dianhydride and an aromatic diamine are polymerized in a solvent to form a soluble precursor polyamic acid, which is solution cast into a film, and then imidized at high temperature to yield a polyimide film. Among various polyimide varieties, polymers based on BPDA, pyromellitic dianhydride (hereinafter, may be abbreviated as PMDA) and p-PDA are especially desirable since they have excellent mechanical properties. These properties are related to their rigid and linear macromolecular structure. Their fully aromatic structure also results in a high thermal decomposition temperature. Japanese patents 5650458 and 6288227 disclose processes where solutions of polyamic acids prepared from these monomers are coated on rigid carrier plates to form films that are thermally imidized, followed by the construction of an electronic device on the film surface. The rigid substrate is separated from the plate to afford a flexible device. However, solutions of polyamic acids prepared from BPDA, PMDA, and p-PDA exhibit high solution viscosity, which makes the film fabrication process difficult. WO 2017/204186, U.S. Pat. No. 8,354,493, and US Patent Application Publication 2020/0407593 disclose processes to lower the polyamic acid molecular weight by end-capping the polymer with mono-anhydrides. Although lowering the molecular weight can lower the viscosity, low molecular weight will lead to reduced film performance, particularly reduced elongation. An approach to overcoming this problem in photosensitive polymer formulations has been disclosed in U.S. Pat. No. 11,294,281. Thus, low molecular weight polyamic acid amine salts were chain extended with tertiary amine salts of tetracarboxylic acids by heating at 350° C. for one hour. However, such a process produces large amounts of amine volatiles and could not be used during the manufacture of displays. The thermal decomposition of the amines also results in unacceptable haze and color. The viscosity of the solution can also be reduced by reducing the solids content, but this will lead to an increase in the cost of film formation, a decrease in the quality of film formation, and increased solvent emission. Thus, a method that uses a solution with a high solids content and a low solution viscosity that can be used to generate a substrate with excellent mechanical, optical, and thermal properties during the manufacture of a display has been difficult to achieve.

Methods disclosed herein address the problems in the prior art of achieving excellent mechanical, optical, and thermal properties with a solution that has a high solids content and a low solution viscosity that can be used to generate a substrate with during the manufacture of a display.

### SUMMARY OF THE INVENTION

A method for the preparation of an aromatic polyimide substrate for optical displays that can be carried out during the manufacture of the display, which includes the steps of applying a solution of an aromatic tetracarboxylic acid or an aromatic tetracarboxylic acid derivative and a low molecular weight polyamic acid on a solid support and heating to 425° C. to 450° C. The polyamic acid is prepared from non-stoichiometric amounts of 3, 3′, 4, 4′-biphenyltetracarboxylic dianhydride (hereinafter, may be abbreviated as BPDA) and p-phenylene diamine (hereinafter, maybe abbreviated as p-PDA). The tetracarboxylic acid is 3, 3′, 4, 4′-biphenyltetracarboxylic acid (hereinafter, may be abbreviated as BPTA) or pyromellitic acid (hereinafter, may be abbreviated as PMA). The solution has a solids content of 15 to 25 percentage by weight (hereinafter, may be abbreviated as wt %) and an apparent viscosity of 2,000 to 10,000 centipoises (hereinafter, may be abbreviated as cPs). The substrate has an elongation to break (hereinafter, may be abbreviated as ε_{break}) of greater than 30%, a modulus greater than 8 giga-pascal (hereinafter, may be abbreviated as GPa), a maximum stress to break (hereinafter, may be abbreviated as σₘₐₓ) greater than 400 mega-pascal (hereinafter, may be abbreviated as MPa), and a yellowness factor b*<25. For display manufacturing, the substrate has a softening temperature above 450° C.

Such a method for the manufacture of a polyimide substrate that can be utilized during the manufacture of a display that generally employs a low viscosity, high solids content solution of a low molecular weight polyamic acid and a tetracarboxylic acid or a tetracarboxylic derivative is disclosed herein. In exemplary methods the precursor solution is cast on a solid substrate and thermally converted to a film, which results in excellent mechanical, optical, and thermal properties.

In one exemplary embodiment of the method, the polyamic acid is prepared from BPDA and/or PMDA and p-PDA using a 2 to 6% molar excess of p-PDA in a polar aprotic solvent. The monomers are polymerized by heating the solution to 50° C. for 2 hours. BPTA or PMA is added before or after polymerization. The molar ratio of dianhydride+tetracarboxylic acid/p-PDA varies from 98/100 to 102/100. The solids content of the solution after the addition of the tetracarboxylic acid is 15 wt % to 25 wt % and the solution viscosity is 2,000 to 10,000 cPs. The solution is applied to a glass substrate, dried with hot air or under reduced pressure at 80 to ° C. 100° C. to remove solvent and then heated at a rate of 2 to 10° C./minute (hereinafter, “minutes” may be abbreviated as min) to 425-450° C. and held there for 10 to 60 min under nitrogen. Alternatively, the heating cycle may be staged so that the sample is held at 100-150° C. for 10-30 min, 150-250° C. for 10-30 min, and 250-450° C. for 10 to 30 min. The polyimide films obtained in this manner have excellent properties, including elongation at break greater than 30%, modulus greater than 8 GPa, and a maximum stress at break greater than 400 MPa. The films also have a yellowness factor b*<25 and a total transmission of over 80%.

### DETAILED DESCRIPTION OF THE INVENTION

The objective of this disclosure is to provide a method whereby a 5-25 micrometer (hereinafter, may be abbreviated as μm) polyimide film substrate can be produced during the manufacture of an optical display that has an elongation at break greater than 30%, a modulus greater than 8 GPa, a maximum stress at failure of greater than 400 MPa, and a yellowness b*<25 at a thickness of 10 μm. The film also does not soften below 450° C. and undergo less than a 1% weight loss when heated to 500° C. in nitrogen. Thus, a low molecular weight polyamic acid is prepared by the reaction of BPDA with excess p-PDA in a polar solvent such as N, N-dimethylformamide (hereinafter, may be abbreviated as DMF), N, N-dimethylacetamide (hereinafter, may be abbreviated as DMAc), N-methylpyrrolidone (hereinafter, may be abbreviated as NMP), N-ethylpyrrolidone (hereinafter, may be abbreviated as NEP), or dimethylsulfoxide (hereinafter, may be abbreviated as DMSO) or mixtures thereof. In certain embodiments, NMP is the preferred solvent. The molar ratio of BPDA to p-PDA varies from 94:100 to 98:100. Although in one embodiment, the solution is heated at 50° C. for 2 hours, other heating cycles can be used. The heating cycle and the offset in monomer ratio are used to help control the molecular weight of the generated polyamic acid and, thus, the solution viscosity. A tetracarboxylic acid or a tetracarboxylic acid derivative is added either prior or after the reaction. In one embodiment, the additive is BPTA, although PMA and other similar compounds may be used. The molar ratio of the additive to the polyamic acid varies from 2 to 8%. The molar ratio of BPDA+BPTA/p-PDA varies from 98/100 to 102/100. The solids content of the solution is set from 15 to 25 wt % so that the solution viscosity is in the range of 2000-10000 cPs at 25° C.

In the exemplary method, the solution containing the two components is then cast on a glass plate, and the solvent removed by a stream of hot air or by heating under reduced pressure at 80-100° C. for 30 min. The glass plate containing the resulting film is then heated at the rate of 1-10° C./min with or without staging at intermediate temperatures to 425 to 450° C. and held there for 10 to 60 min. Preferably, the heating cycle is staged so that the sample is held at 100-150° C. for 10-30 min, 150-250° C. for 10-30 min, and 250-450° C. for 10 to 30 min. In order to achieve the required thermal properties, in particular a softening temperature above 450° C., it has been discovered that the film must be heated to a minimum of 425° C. During this method, the polyamic acid is chain extended by reaction with the tetracarboxylic acid or tetracarboxylic acid derivative and thermally imidized. In this manner, a polyimide film is obtained that displays the targeted properties. This method can be the initial step in the manufacture of the optical display, which is conducted on the film surface. The final step is the stripping of the hard substrate from the completed optical display so that the electronics of the optical display can be attached to the polyimide film.

The following are descriptions of experiments conducted to verify the methods and the resulting properties.

Film Preparation: Generally, the film preparation includes a solution of the tetracarboxylic acid or tetracarboxylic acid derivative and the polyamic acid poured on a glass substrate to coat the glass substrate. The viscous solution is leveled and the eventual film thickness controlled using a doctor blade with different gaps. After the majority of the solvent is removed with hot air or by heating under reduced pressure at 80° C. to 100° C. for 30 min, the glass substrate is heated under nitrogen as follows: first at the rate of 5° C./min to 150° C. and held there for 15 min; next it is heated at the rate of 5° C./min to 250° C. and held there for 15 min; and finally it is heated at the rate of 5° C./min to 450° C. and held there for 30 min. The resulting polyimide film was then peeled from the substrate. Only in comparative example 4, after most of the solvent was removed the glass substrate containing the film was heated using the heating protocol only changing the final temperature to 350° C.

Solution Viscosity: The solution viscosity is measured at 25° C. using a Brookfield DV-I viscometer.

Thermal Properties: The softening temperature is determined with a TA TMA 450EM thermal mechanical analyzer using a heating rate of 10° C./min. The softening temperature is taken as the extrapolated onset temperature of the change in dimension in a plot of dimension vs. temperature.

Mechanical Properties: The mechanical properties of the film are measured using an INSTRON 5969 tensometer. Film samples with a thickness of 10 μm to 20 μm, which are prepared from NMP solutions, are stretched at room temperature at a rate of 10 mm/min.

Optical Properties: Optical properties of 10 μm films are determined on an Ultrascan VIS Hunterlab. Yellowness factor b*, haze, and total transmission of over 80% (hereinafter, may be abbreviated as Y total) are used for comparison.

Examples: Four “comparative examples” and nine additional examples were prepared and tested.

Comparative Example 1: The following were added to a 300 milliliter (hereinafter, may be abbreviated as ml) round bottom flask equipped with a mechanical stirrer, a nitrogen inlet, and a condenser: 91.65 g of NMP and 50.00 millimole (hereinafter, may be abbreviated as mmol) of p-PDA. Then 50.00 mmol of BPDA was added to the flask under nitrogen flow resulting in a solids content of 18 wt %. The solution was stirred and heated at 50° C. under nitrogen for 2 hours. The solution became extremely viscous. The apparent viscosity was greater than 400,000 cPs, which is beyond the measurable upper limit of viscometer. Because the viscosity of the solution was so high, it was difficult to cast a smooth film. Due to the difficulty in forming a flat film, the physical parameters of the film could not be determined.

Comparative Example 2: The following were added to a 300 ml round bottom flask equipped with a mechanical stirrer, a nitrogen inlet, and a condenser: 69.76 g of NMP, 50.00 mmol of p-PDA, and 48.50 mmol of BPDA. The solution was stirred and heated at 50° C. under nitrogen for 2 hours. An additional 19.88 g of NMP was added and mixed well reducing the solids content to 18.0 wt %. The solution apparent viscosity was 8000 cPs.

Comparative Example 3: The following were added to a 300 ml round bottom flask equipped with a mechanical stirrer, a nitrogen inlet, and a condenser: 58.15 g of NMP and 50.00 mmol of p-PDA. BPDA (47.50 mmol) was then added under a nitrogen flow. The solution was stirred and heated at 50° C. under nitrogen for 2 hours. Additional NMP (24.48 g) was then added and mixed well reducing the solids content to 19.0 wt %. The solution apparent viscosity was 4400 cPs.

Comparative Example 4: The following was added to a 300 ml round bottom flask equipped with a mechanical stirrer, a nitrogen inlet, and a condenser: 68.72 g of NMP and 47.50 mmol of BPDA. Then 50.00 mmol of p-PDA was added under a nitrogen flow, and the solution was stirred and heated at 50° C. under nitrogen for 2 hours. BPTA (2.00 mmol) and 16.73 g NMP were added and mixed well reducing the solids content to 19.0 wt %. The solution apparent viscosity was 3400 cPs. In this case, after the solution was cast on a glass plate and the majority of the solvent was removed with hot air or by heating under reduced pressure at 80 to 100° C. for 30 min, the substrate was heated under nitrogen at the rate of 5° C./min to 150° C. and held there for 15 min; then heated at the rate of 5° C./min to 250° C. and held there for 15 min; and finally heated at the rate of 5° C./min to 350° C. and held there for 30 min.

Example 1: The following were added to a 300 ml round bottom flask equipped with a mechanical stirrer, a nitrogen inlet, and a condenser: 69.76 g of NMP and 50.00 mmol of p-PDA. Then 48.50 mmol of BPDA was added under a nitrogen flow, the solution was stirred and heated at 50° C. under nitrogen for 2 hours. BPTA (1.00 mmol) and 21.38 g NMP were then added and mixed well reducing the solids content to 18.0 wt %. The solution apparent viscosity was 9800 cPs.

Example 2: The following were added to a 300 ml round bottom flask equipped with a mechanical stirrer, a nitrogen inlet, and a condenser: 69.76 g of NMP and 50.00 mmol of p-PDA. Then 48.50 mmol of BPDA was added under nitrogen flow, the solution was stirred and heated at 50° C. under nitrogen for 2 hours. BPTA (1.50 mmol) and 22.13 g NMP were then added and mixed well reducing the solids content to 18.0 wt %. The solution apparent viscosity was 7000 cPs.

Example 3: The following were added to a 300 ml round bottom flask equipped with a mechanical stirrer, a nitrogen inlet, and a condenser: 69.76 g of NMP and 50.00 mmol of p-PDA. Then 48.5 mmol of BPDA was added under nitrogen flow, the solution was stirred and heated at 50° C. under nitrogen for 2 hours. BPTA (2.00 mmol) and 22.88 g NMP were then added and mixed well reducing the solids content to 18.0 wt %. The solution apparent viscosity was 7000 cPs.

Example 4: The following were added to a 300 ml round bottom flask equipped with a mechanical stirrer, a nitrogen inlet, and a condenser: 58.15 g of NMP and 50.00 mmol of p-PDA. Then 47.50 mmol of BPDA was added under nitrogen flow, the solution was stirred and heated at 50° C. under nitrogen for 2 hours. BPTA (2.00 mmol) and 27.30 g NMP were then added and mixed well reducing the solids content to 19.0 wt %. The solution apparent viscosity was 3900 cPs.

Example 5: The following were added to a 300 ml round bottom flask equipped with a mechanical stirrer, a nitrogen inlet, and a condenser: 58.15 g of NMP and 50.00 mmol of p-PDA. Then 47.50 mmol of BPDA was added under a nitrogen flow, the solution was stirred and heated at 50° C. under nitrogen for 2 hours. BPTA (2.50 mmol) and 28.00 g NMP were added and mixed well reducing the solids content to 19.0 wt %. The solution apparent viscosity was 3900 cPs.

Example 6: The following were added to a 300 ml round bottom flask equipped with a mechanical stirrer, a nitrogen inlet, and a condenser: 58.15 g of NMP and 50.00 mmol of p-PDA. Then 47.50 mmol of BPDA was added under nitrogen flow, the solution was stirred and heated at 50° C. under nitrogen for 2 hours. BPTA (3.00 mmol) and 28.71 g NMP were then added and mixed well reducing the solids content to 19.0 wt %. The solution apparent viscosity was 3800 cPs.

Example 7: In order to show that the monomer charging sequence does not prevent the formation of a film with the desired properties, the following experiment was carried out. The following were added to a 300 ml round bottom flask equipped with a mechanical stirrer, a nitrogen inlet, and a condenser: 68.72 g of NMP and 47.50 mmol of BPDA. p-PDA (50.00 mmol) was then added under nitrogen flow. Then the solution was stirred and heated at 50° C. under nitrogen for 2 hours, 2.00 mmol BPTA and 16.73 g NMP were added and mixed well reducing the solids content to 19.0 wt %. The solution apparent viscosity was 3400 cPs.

Example 8: In order to further show that the monomer charging sequence does not prevent the formation of a film with the desired properties, the following experiment was carried out. The following was added to a 300 ml round bottom flask equipped with a mechanical stirrer, a nitrogen inlet, and a condenser: 68.72 g of NMP and 47.50 mmol of BPDA. p-PDA (50.00 mmol) was then added under a nitrogen flow. Then the solution was stirred and heated at 50° C. under nitrogen for 2 hours, 2.50 mmol BPTA and 17.43 g NMP were added and mixed well reducing the solids content to 19.0 wt %. The solution apparent viscosity was 2900 cPs.

Example 9: In order to further show the monomer charging sequence does not prevent the formation of a film with the desired properties, the following experiment was carried out. The following was added to a 300 ml round bottom flask equipped with a mechanical stirrer, a nitrogen inlet, and a condenser: 75.40 g of NMP, 47.50 mmol of BPDA, and 2.00 mmol of BPTA. Then 50.00 mmol of p-PDA was added under a nitrogen flow, the solution was stirred and heated at 50° C. under nitrogen for 2 hours. An additional 10.05 g NMP was added and mixed well reducing the solids content to 19.0 wt %. The solution apparent viscosity was 4100 cPs.

Table 1 below lists the molar ratio of BPTA and BPDA to p-PDA and optical properties of comparative examples and other examples. For example 9, the BPTA was added prior to preparation of polyamic acid. As shown in the Table 1, the comparative examples 2 and 3, which were made without BPTA, have b* higher than 29. In examples 1-9, the molar ratio of BPTA and BPDA to p-PDA was close to 100:100. This resulted in a reduction in film color. All b* values are less than 25.

TABLE 1

| | BPDA:BTDA:p-PDA | | | Y total | Thickness |
|---|---|---|---|---|---|
| Example | Molar Ratio | b* | Haze | % | μm |
| Comparative | 97.0:0.0:100.0 | 29.6 | 0.2 | 80.0 | 10 |
| example 2 | | | | | |
| Comparative | 95.0:0.0:100.0 | 29.4 | 0.2 | 80.0 | 10 |
| example 3 | | | | | |
| Example 1 | 97.0:2.0:100 | 23.9 | 0.18 | 81.0 | 10 |
| Example 2 | 97.0:3.0:100 | 21.4 | 0.18 | 81.0 | 10 |
| Example 3 | 97.0:4.0:100 | 20.7 | 0.19 | 80.4 | 10 |
| Example 4 | 95.0:4.0:100 | 20.0 | 0.14 | 81.3 | 10 |
| Example 5 | 95.0:5.0:100 | 21.4 | 0.17 | 80.7 | 10 |
| Example 6 | 95.0:6.0:100 | 22.9 | 0.20 | 80.0 | 10 |
| Example 7 | 95.0:4.0:100 | 22.3 | 0.14 | 80.6 | 10 |
| Example 8 | 95.0:5.0:100 | 20.0 | 0.15 | 80.5 | 10 |
| Example 9 | 95.0:4.0:100 | 23.5 | 0.15 | 80.6 | 10 |

Table 2 lists the molar ratio of BPTA and BPDA to p-PDA and softening temperature for two examples. In comparative example 4, the final heating temperature of the film was 350° C. The softening temperature is significantly lower than in example 7. The heating process is crucial to the performance of the polyimide film.

TABLE 2

| | BPDA:BTDA:p-PDA | Softening |
|---|---|---|
| Example | Molar Ratio | Temperature ° C. |
| Comparative | 95.0:4.0:100 | 369 |
| example 4 | | |
| Example 7 | 95.0:4.0:100 | 481 |

Table 3 lists the molar ration of BPTA and BPDA to p-PDA and certain mechanical properties of several examples. The films prepared in comparative examples 2 and 3 from polyamic acid solutions not containing BPTA have poor mechanical properties. The elongation at break is less than 20%. The maximum stress at break is also less than 400 MPa. The films prepared in examples 1-9 from solutions containing BPTA have excellent mechanical properties. In these solutions, the molar ratio of BPTA and BPDA to p-PDA is close to 100:100. All the samples have an elongation at break higher than 30% and the maximum stress at break is greater than 400 MPa.

TABLE 3

| | BPDA:BTDA:p-PDA | Thickness | Modulus | σₘₐₓ | ε_{break} |
|---|---|---|---|---|---|
| Example | Molar Ratio | μm | Gpa | Mpa | (%) |
| Comparative | 97.0:0.0:100.0 | 20 | 9.0 ± 0.5 | 370 ± 30 | 20 ± 5 |
| example 2 | | | | | |
| Comparative | 95.0:0.0:100.0 | 20 | 8.9 ± 0.4 | 290 ± 20 | 11 ± 3 |
| example 3 | | | | | |
| Example 1 | 97.0:2.0:100 | 20 | 8.6 ± 0.3 | 540 ± 70 | 44 ± 9 |
| Example 2 | 97.0:3.0:100 | 20 | 8.2 ± 0.3 | 500 ± 100 | 40 ± 10 |
| Example 3 | 97.0:4.0:100 | 20 | 8.3 ± 0.3 | 470 ± 60 | 39 ± 9 |
| Example 4 | 95.0:4.0:100 | 20 | 8.4 ± 0.3 | 420 ± 30 | 30 ± 4 |
| Example 5 | 95.0:5.0:100 | 20 | 8.3 ± 0.3 | 530 ± 20 | 43 ± 8 |
| Example 6 | 95.0:6.0:100 | 20 | 8.4 ± 0.3 | 460 ± 50 | 33 ± 6 |
| Example 7 | 95.0:4.0:100 | 20 | 8.4 ± 0.3 | 490 ± 50 | 38 ± 7 |
| Example 8 | 95.0:5.0:100 | 20 | 8.3 ± 0.3 | 490 ± 60 | 40 ± 10 |
| Example 9 | 95.0:4.0:100 | 20 | 8.2 ± 0.3 | 470 ± 60 | 37 ± 6 |

We claim:

1. A method for the preparation of an aromatic polyimide substrate for optical displays that can be carried out during the manufacture of the display, comprising the steps of:
casting a solution of an aromatic tetracarboxylic acid or an aromatic tetracarboxylic acid derivative and a low molecular weight polyamic acid in a polar organic solvent on a solid support in the form of a film, where said polyamic acid was obtained by polymerizing a 3, 3′, 4, 4′-biphenyltetracarboxylic dianhydride with an excess of p-phenylene diamine, where said aromatic tetracarboxylic acid or aromatic tetracarboxylic acid derivative have the structure: 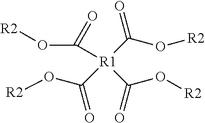
where R1 is: 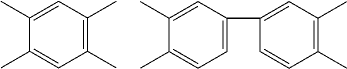
where R2 is hydrogen or an alkyl group or mixtures of the two;
evaporating most of the solvent either with a stream of hot air of nitrogen or by heating under reduced pressure to afford a polyamic acid film; and
heating the polyamic acid film on the support at a temperature of not lower than 425° C. to afford a polyimide film.

2. The method for the preparation of an aromatic polyimide substrate as defined in claim 1, where an optical display is constructed directly on the polyimide film on the support using known techniques; and the step of stripping the support from the polyimide film so that the electronics of the display are attached to the polyimide substrate.

3. The method for the preparation of an aromatic polyimide substrate as defined in claim 1, where the tetracarboxylic acid is 3, 3′, 4, 4′-biphenyltetracarboxylic acid or pyromellitic acid.

4. The method for the preparation of an aromatic polyimide substrate as defined in claim 1, where the molar ratio of 3, 3′, 4, 4′-biphenyltetracarboxylic dianhydride to p-phenylene diamine is between 94:100 and 98:100.

5. The method for the preparation of an aromatic polyimide substrate as defined in claim 1, where the molar ratio of 3, 3′, 4, 4′-biphenyltetracarboxylic dianhydride plus 3, 3′, 4, 4′-biphenyltetracarboxylic acid to p-phenylene diamine is from 98:100 to 102:100,

6. The method for the preparation of an aromatic polyimide substrate as defined in claim 1, where the polyamic acid is prepared in the solution prior to or after the addition of the aromatic tetracarboxylic acid or aromatic tetracarboxylic acid derivative.

7. The method for the preparation of an aromatic polyimide substrate as defined in claim 1, where the polar organic solvent is N, N-dimethylformamide, N, N-dimethylacetamide, N-methylpyrrolidone, N-ethylpyrrolidone, dimethylsulfoxide, or mixtures of these solvents.

8. The method for the preparation of an aromatic polyimide substrate as defined in claim 1, where the molar ratio of the aromatic tetracarboxylic acid or aromatic tetracarboxylic acid derivative to 3, 3′, 4, 4′-biphenyltetracarboxylic dianhydride is from 7:93 to 2:98.

9. The method for the preparation of an aromatic polyimide substrate as defined in claim 1, where the solids content of the solution is 15 to 25 wt % and the solution apparent viscosity is 2,000 to 10,000 cPs.

10. The method for the preparation of an aromatic polyimide substrate as defined in claim 1, where the polyimide film is 5-25 μm thick.

11. The method for the preparation of an aromatic polyimide substrate as defined in claim 1, where the polyimide film has an elongation at break greater than 30%, a modulus greater than 8 GPa, a maximum stress at break greater than 400 MPa, and a softening temperature greater than 450° C.

12. The method for the preparation of an aromatic polyimide substrate as defined in claim 9, where the polyimide film is 10 μm thick and has a yellowness factor, b*<25 as determined by Ultrascan VIS Hunterlab and a total transmission of greater than 80%.
